(19) United States
(12) Patent Application Publication
(10) Pub. No.: US 2026/0018932 A1
(43) Pub. Date: Jan. 15, 2026

(54) Combined Wireless and Surface Connection Charger

(71) Applicant: Magfast LLC, Cornwall On Hudson, NY (US)

(72) Inventors: Seymour Segnit, Cornwall On Hudson, NY (US); Filip Spasev, Sveti Nikole (MK)

(21) Appl. No.: 19/185,395

(22) Filed: Apr. 22, 2025

Related U.S. Application Data
(60) Provisional application No. 63/637,062, filed on Apr. 22, 2024.

(51) Int. Cl. H02J 50/12; G09F 23/06; H01R 12/71; H01R 13/24; H01R 13/642; H01R 43/16; H02J 7/00; H02J 50/80; H02J 50/90; H04B 5/79

(52) U.S. Cl. CPC H02J 50/12; G09F 23/06; H01R 12/714; H01R 13/2421; H01R 13/2471; H01R 13/642; H01R 43/16; H02J 7/00034; H02J 50/80; H02J 50/90; H04B 5/79; H02J 7/0044; H02J 2207/30

(57) ABSTRACT

A hybrid charge and data transfer system includes a transmission station and a mobile device with a data and power connection therebetween. The transmission station includes a transmitter coil, communication circuitry, a power conversion mechanism, and a surface mount connection to provide a direct connection between the transmitter and receiver to allow two-way communication and power transfer both wirelessly and by direct connection. The mobile device has a receiver coil, communication circuitry, and power pickup circuitry and a surface mount having a number of pin or pad connections to allow a direct connection between the transmitter and receiver which provides two-way communication and power transfer both wirelessly and by direct connection. The hybrid system may also provide a connection from the surface mount to the memory/CPU of the transmission station and the mobile device for data transfer as well as to the load or battery for charging. The surface mount may include electronic pin connectors include electronic pin connectors arranged in a grid pattern or a number of surface connections.

### BACKGROUND OF THE INVENTION

This claims the benefit of U.S. Provisional Patent Application Ser. No. 63/637,062, filed Apr. 22, 2024 which is hereby incorporated by reference in its entirety.

This invention relates a hybrid charger and data management system for supporting and charging electronic components such as phones, tablets, readers, and other low voltage devices. This invention also allows for the transfer of data and meta data between a user's electronic device and a charge unit for contact or non-contact charging and data communication under a wireless protocol such as Qi for charging, USB for power, data transfer, and video output and NFC (Near Field Communication) for close-range connections to exchange data for contactless payments, ticketing, and data transfer between smartphones, wearables, and other compatible devices.

Large numbers of charging devices and electronic devices are known in the art. Generally, a charging device includes a high frequency transformer to produce a fully isolated and regulated low DC voltage at an extremely low amperage suitable for charging the electronic component. The power input is generally a residential 120V 60 Hz source in North America and 220V-250V at 50-60 Hz outside of North America. Typically, the transformer base portion is plugged into a wall outlet and a cable connects the electronic device to the base.

Qi wireless charging and USB-C charging are two popular methods for powering electronic devices, each with distinct features and advantages.

Qi wireless charging utilizes electromagnetic induction to transfer power between a charging pad and a compatible device. It offers convenience by eliminating the need for cables and connectors, allowing users to simply place their device on the charging pad to initiate charging. Qi chargers typically operate at lower power levels, ranging from 5 to 240 watts, which may result in slower charging compared to wired methods. However, recent advancements in Qi technology have introduced higher power capabilities, enabling faster charging speeds.

In contrast, USB-C charging relies on a physical connection between the device and a power source using a USB-C cable. USB-C ports support higher power delivery, ranging from 15 to 100 watts or more, depending on the devices, cables and charging protocol. This allows for rapid charging of compatible devices, including smartphones, laptops, and tablets. USB-C also offers versatility, as the same cable can be used for charging, data transfer, and video output.

Qi wireless charging and USB-C charging adhere to industry standards to ensure reliable and secure power delivery. Qi chargers incorporate features such as foreign object detection and temperature monitoring to prevent overheating and resulting damage to devices. USB-C charging protocols include built-in safeguards against overvoltage, overcurrent, and short circuits to protect both the device and the charging source. In a Qi system there is a Transmitter Module (TX) and a receive module (RX). Transmitter (TX) Module typically includes one or more of the following features:
Converts DC input (typically 5-20V) into a high-frequency AC voltage (50-100 VAC);
Uses integrated circuits (ICs) and a TX coil to generate an alternating magnetic field at a frequency of 100-120 kHz;
The AC signal energizes a resonant tank circuit, creating a tuned magnetic field for wireless power transfer;
Continuously monitors for the presence of a Qi-compatible receiver by sending out periodic “ping” signals;
Once a receiver is detected, the TX module negotiates power requirements and begins energy transfer;
Adjusts output dynamically based on feedback from the RX module to optimize efficiency and ensure safety (e.g., Foreign Object Detection); and
Includes control electronics for communication, power regulation, and safety features.

The Receiver (RX) Module typically includes one or more of the following features:
Contains its own ICs and an RX coil to capture the magnetic field generated by the TX module;
Converts the induced AC voltage back into DC power using a rectifier circuit;
Supplies power to charge a battery or directly power a device;
Fine-tunes the power transfer efficiency using resonant LC tank circuits (series and parallel capacitors with the RX coil);
Communicates with the TX module to report power requirements and transfer status, enabling dynamic adjustment of power delivery; and
Implements safety and control protocols, including Foreign Object Detection and end-of-charge signaling.

Near Field Communication (NFC) enables short-range wireless communication between compatible devices, typically within a few centimeters. It facilitates data transfer, such as payment information, contactless transactions, or information exchange between NFC-enabled devices, like smartphones, payment terminals, or smart tags. When devices are brought into close proximity, NFC establishes a connection and initiates data transfer, leveraging radio frequency technology. This secure and convenient method is widely used for contactless payments, ticketing, access control, and device pairing. NFC data transfer simplifies interactions and enhances user experiences by enabling quick and simple communication between devices in various applications.

The safety features of typical NFC systems include: USB-C and USB PD protocols to prevent accidental over-voltage or electric shock. The power source and the cable itself are designed to ensure that higher voltages are not presented unless a proper connection and communication have been established with a compatible device.

### SUMMARY OF THE INVENTION

This invention provides a hybrid charger and data transfer system, with a transmission station and a mobile device with a data and power connection therebetween. The transmission station may include a transmitter coil, communication circuitry, a power conversion mechanism, and a surface mount connection to provide a direct connection between the transmitter and receiver to allow two-way communication and power transfer both wirelessly and by direct connection. The mobile device may have a receiver coil, communication circuitry, power pickup circuitry and a surface mount having a number of pin or pad connections to allow for a direct connection between the transmitter and the receiver which provides two-way communication and power transfer both wirelessly and by direct connection. The hybrid system according to various embodiments may also provide a connection from the surface mount to the memory/CPU of the transmission station and the mobile device for data transfer as well as to the load or battery for charging. The surface mount may include electronic pin connectors having a series of conductive pins arranged in a grid pattern or a number of surface connections.

### BRIEF DESCRIPTION OF THE DRAWINGS

A more complete appreciation of the invention and the many embodiments thereof will be readily obtained as the same becomes better understood by reference to the following detailed description when considered in connection with the accompanying drawings, wherein:

FIG. 1 is a schematic of a base of a printed circuit board (PCB) according to one embodiment and suitable for use with this invention;

FIG. 2 is a schematic of a top of a surface connector according to one embodiment and suitable for use with this invention;

FIG. 2 is a schematic of a top of a surface connector according to one embodiment and suitable for use with this invention;

FIG. 3 is a hybrid Qi physical connection charger unit according to one embodiment of this invention;

FIG. 4 is a schematic of a spring-loaded electrical connector, known as a POGO Pin according to one embodiment and suitable for use in this invention;

FIG. 5 is a schematic of a schematic of a hybrid wireless system and direct “wired” system for power and data transfer according to one embodiment of this invention;

FIG. 6A is a schematic view of a charge unit for a hybrid power and data transfer system according to one embodiment of this invention;

FIG. 6B is a schematic view of stacked charge units for a hybrid power and data transfer system according to one embodiment of this invention;

FIG. 7 is a perspective view of a freestanding connector base unit with an electronic device, such as a cell phone for a hybrid power and data transfer system according to one embodiment of this invention;

FIG. 8A is a schematic of a single charge port, charge unit for a hybrid power and data transfer system according to one embodiment of this invention;

FIG. 8B is a schematic of a multiple charger, charge unit for a hybrid power and data transfer system according to one embodiment of this invention; and

FIG. 9 is a freestanding connector base unit with multiple chargers for a hybrid power and data transfer system according to one embodiment of this invention.

### DETAILED DESCRIPTION OF THE INVENTION

This invention in various embodiments provides a hybrid system for charging and data transfer by both wireless and direct connection. Both a mobile device and a charge base may have a receiver coil, communication circuitry, and power pickup circuitry and a surface mount having a number of pin or pad connections to allow for a direct connection between the transmitter and receiver which provides two-way communication and power transfer both wirelessly and by direct connection. The hybrid system according to various embodiments of this invention may also provide a connection from the surface mount to the memory/CPU of the transmission station and the mobile device for data transfer as well as to the load or battery for charging. The surface mount may include electronic pin connectors include a series of conductive pins arranged in a grid pattern or a number of surface connections.

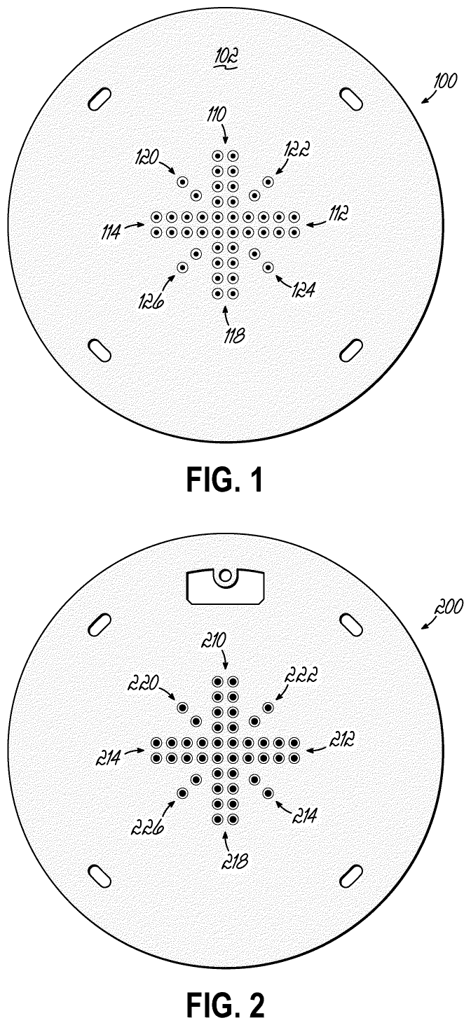

FIG. 1 shows one Receiver Module (RX) structure 100 for the hybrid surface mounted connection structure according to various embodiments of this invention. The RX structure 100 may include a printed circuit board (PCB) 102 with a 4-way rotational structure defined by arrays of positioning/detection connections 120, 122, 124, 126. Positioning connections 120, 122, 124, 126 may match with positioning pins on a transmitter module to determine that a transmitter module (TX) exists. If present, the system switch will switch the input power from a wireless to the physical connection according to various embodiments of this invention. There may be four groups of voltage bus (Vbus) and 4 groups of Ground (GND) connections 110, 112,114, 118 in the hybrid module according to various embodiments of this invention thereby allowing power output up to 140 W (28v 5 A).

FIG. 2 shows one Transmitter Module (TX) structure 200 for the hybrid surface mounted connection structure according to various embodiments of this invention. Structure 200 may include PCB with a 4-way rotational structure defined by arrays of positioning/detection connections 220, 222, 224, 226. Positioning pins 220, 222, 224, 226 may match with positioning connections on a transmitter module to determine that an RX is present. If present, the system may switch the input power to from a wireless to the physical connection according to various embodiments of this invention. There may be four groups of voltage bus (Vbus) and four groups of Ground (GND) pins 210, 212, 214, 218 according to various embodiments of this hybrid module, allowing power output up to 140 W (28v 5 A). Various embodiments of this invention may support USB3.1 and 10 Gbps multi-group high-speed transfer switches, and the module may retain the full data function Pin of Type-C, to achieve high-speed data transmission of up to 10 Gbps in four directions: North, East, South, West (0, 90, 180 and 270 degrees) positioning.

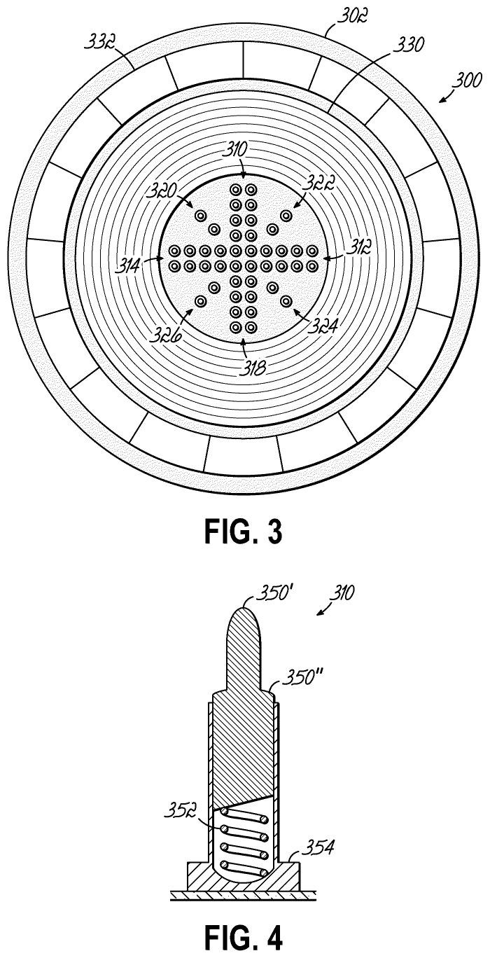

FIG. 3 shows a connection assembly 300 according to various embodiments of this invention including a transmitter module 200 of FIG. 2, with a magnetic ring 332 for use with Qi connections such as the Apple MagSafe, or similar systems. Outer ring 332 may also be a ground for use in the electrical connection. Connection assembly 300 may also include a base 302 as well as induction coil 330 as specified within the Qi system Model Context Protocol (MCP). The voltage bus (Vbus) and four groups of Ground (GND) pins 210, 212, 214, 218 are shown within the Qi coil 330.

FIG. 4 shows a POGO style pushpin 310 structure suitable for use with various embodiments of this invention. Pushpin 310 may include a plunger with a distal end 350′ and a shoulder 350″, a spring mechanism 352 and a housing 354. Distal end 350′ and shoulder 350″ may form the contact portion of POGO pin 310 which may extend and/or retract to maintain contact. The spring 352 may be made from a conductive material to maintain electrical connectivity between the distal end 350 and the housing 354 during retraction and extension thereby providing the POGO pin 310 with its distinctive functionality. The housing 354 may encapsulate and protect the spring 352 and the shoulder 350″ of the POGO pin 310. This structural element ensures mechanical resilience and stability when connected and disconnected.

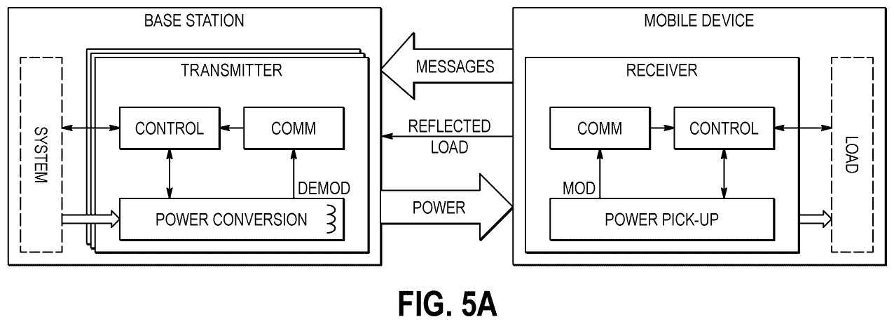

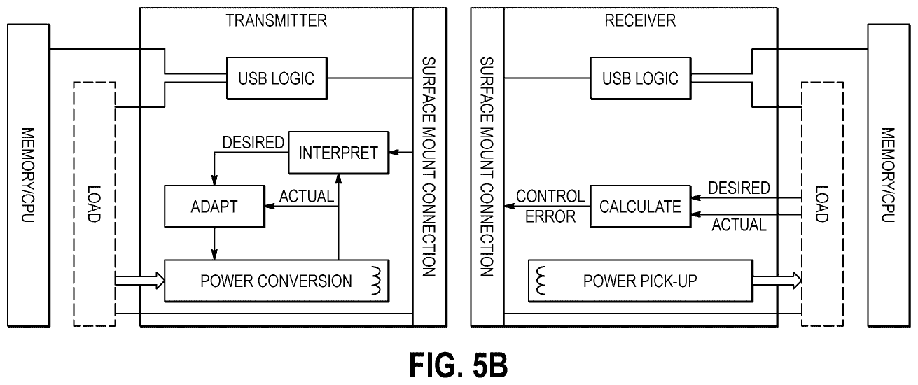

FIG. 5 shows a schematic of a connection according to various embodiments of this invention. The base station or TX may include a transmitter coil, communication circuitry, and a power conversion mechanism. The transmitter coil may generate an alternating magnetic field when powered, which may serve as the medium for wireless power transfer. The communication circuitry may facilitate bi-directional communication between the base station and the mobile device to thereby enable data exchange and negotiation of power transfer parameters. Power conversion mechanisms may convert alternating current (AC) from the main power supply into the required direct current (DC) for the transmitter coil and communication circuitry. The mobile device (RX) may include a receiver coil, communication circuitry, and power pickup circuitry. The receiver coil may capture the magnetic field generated by the transmitter coil and convert it into electrical energy through electromagnetic induction. The communication circuitry may enable bi-directional communication with the base station, allowing the mobile device to negotiate power transfer parameters and receive status updates. The power pickup circuitry may rectify the induced alternating current (AC) and convert it into direct current (DC) for charging the device's battery. Additionally, the load circuitry may manage power distribution within the mobile device to ensure efficient charging and device operation. The connection between the TX and the mobile device (RX) may involve two-way communication and power transfer. Messages exchanged between the base station and the mobile device may include negotiation of power transfer parameters such as charging current and voltage. Power transfer may occur through electromagnetic induction, wherein the alternating magnetic field generated by the transmitter coil induces an electric current in the receiver coil of the mobile device. This current may then be rectified and used to charge the mobile device's battery.

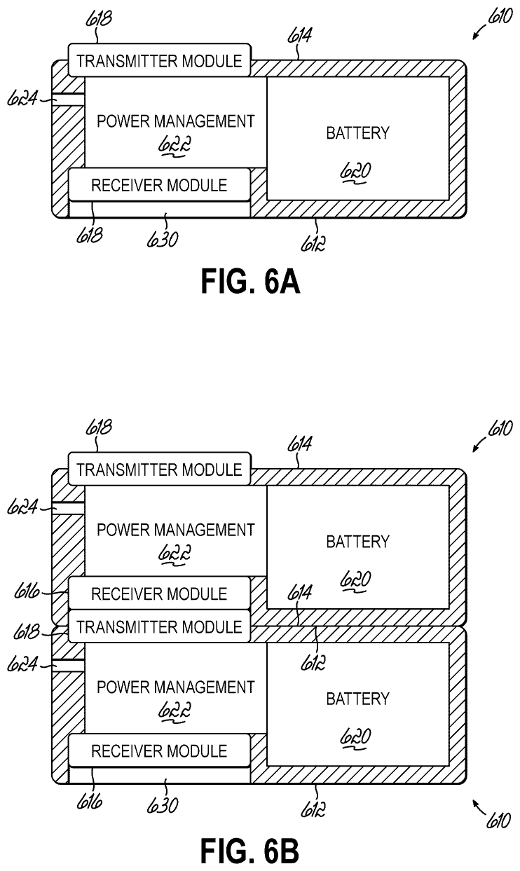

FIG. 6A shows a power pack 610 in accordance with various embodiments of this invention. The power pack 610 may include an upper surface with a transmitter module 618 and a lower surface 612 with a receiver module 616 centered on a recess 630. The power pack 610 may also include a charge port such as a female USBC connection 624, a power management section 622, and a battery 620. The power management section 622 may manage power distribution from a connection 624 to the transmitter module 618 and/or the battery 620. The power management section 622 may also manage power distribution from a receiver module to a transmitter module 618 and/or battery 620.

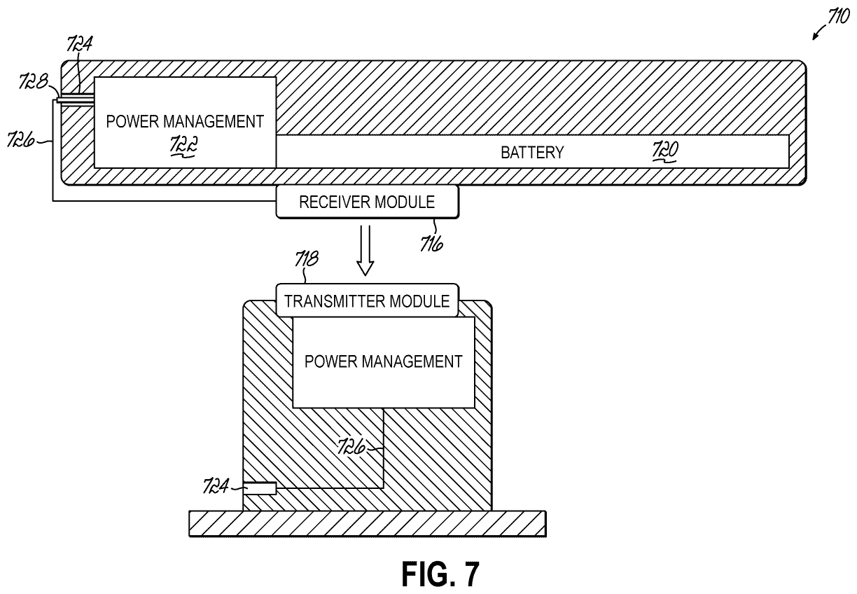

FIG. 6B shows a number of stacked power packs 610 including a first (lower) power pack having an upper surface and transmitter module 618 with a second power pack 610 where the lower surface 612 and receiver module 616 centered on recess 630 is mounted on the first power pack according to various embodiments of this invention. When mounted, the power management sections 622 of each power pack 610 may handshake to control the transfer of power from the lower pack via transmitter module 618 to the upper pack 610 via the receiver module 616. Any number of power packs 610 may be stacked for charging according to various embodiments of this invention. The lower pack 610 may transfer power from the battery 620, the connection 624 and/or from a base unit as shown in FIG. 7. As shown in FIG. 6A, each power pack 610 may also include a connection 624, a power management section 622, and the battery 620.

FIG. 7 shows a portable electronic device 714 mounted on a charge base 730 according to various embodiments of this invention. The device 714 may be any sort of electronic component such as a phone, a tablet, a reader, and other low voltage devices. The device 714 may include a battery 720, and a power management section 722 and may include other devices such as screens, speakers, memory, circuit boards, logic circuits and/or processors. The device 714 may also include charge port 724 with a receiver module 716 and an electronic connection 726. The electronic connection 726 may be a link to connection 728, typically through the use of an aftermarket case that includes the receiver module 716. Alternatively, the receiver module 716 may link directly to a power manager 722. The charge unit 730 may include the base 730, the charge port 724, the power unit 720 and the electrical connection 726. The power unit 722 may be linked to the charge port 724 and the transmitter module 718. When portable electronic device 714 is mounted on the charge unit 730, the transmitter module 718 and the receiver unit 716 may shake hands to determine the charge state of the battery 720 and transfer power from the base 730 to the device 714.

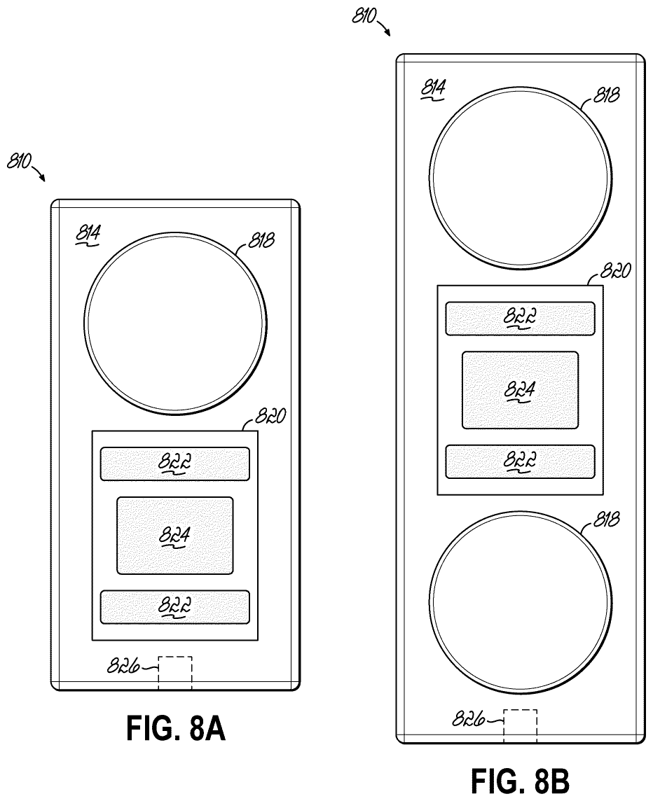

FIG. 8A shows a schematic of a power pack 810 having an upper surface 814, a transmitter module 818, and an interface 820 with any number of display elements such 822 and control surfaces 824 according to various embodiments of this invention. The power pack 810 may include an electrical connection 824 as well as a lower surface with a receiver module centered on a recess with an internal battery and power manager.

FIG. 8B shows a schematic of a multi-connection power pack 810 having an upper surface 814, two or more transmitter module 818 and an interface 820 with any number of display elements 822 and control surfaces 824 according to various embodiments of this invention. The power pack 810 may include an electrical connection 824 as well as a lower surface with one or more receiver modules centered on a recess, with an internal battery and power manager.

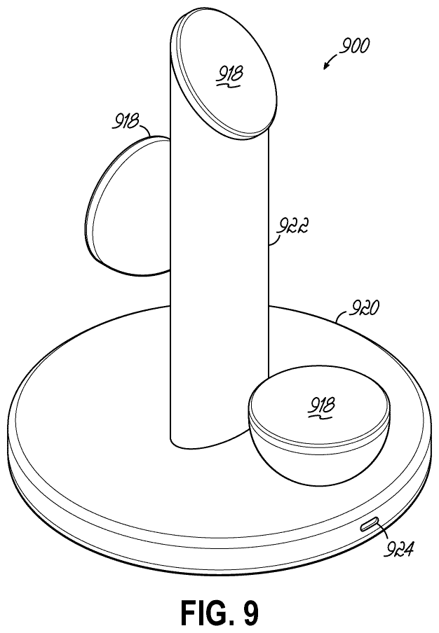

FIG. 9 shows a charge unit 900 with a base 920 and a vertical extension 920 according to various embodiments of this invention. The position and design of the charge unit 900 may vary, but may include an electrical connection 924, and a number of transmitter units 918.

The hybrid surface mount according to various embodiments of this invention may include any number of pin or pad electrical connections. One surface mount may have a number of surface connections, which may be electroplated, sputtered, chemical vapor deposited, physical vapor deposition, thermal sprayed, screen printed or any other suitable process. The opposing surface mount may have a surface coating applied thereto; however, a pin connector may provide a versatile and reliable solution. The electronic pin connectors may include a series of conductive pins arranged in a grid pattern that are spring loaded and/or on a flexible substrate material such as polyimide or polyester film. The pins may have a highly conductive material such as copper. The pins may maintain electrical continuity even when subjected to bending, twisting, or flexing. This flexibility makes them ideal for many applications where traditional rigid connectors would be impractical or unreliable.

The base station and receiver may each include a transmitter coil, communication circuitry, and a power conversion mechanism as in a wireless system with an added logic system that interprets and transfers data and manages a wired power transfer. As with a standard wireless connection protocol, the connection between the base station and the mobile device may involve two-way communication and power transfer. Messages exchanged between the base station and the mobile device may include negotiation of power transfer parameters such as charging current and voltage.

In various embodiments of this invention, power transfer may occur through electromagnetic induction and/or through a wired system using a protocol such as the USB-C power transfer protocol for flexible and efficient power delivery between devices, supporting fast charging, data transfer, and other functionalities through a single, versatile connector. USB-C power delivery (USB PD) is a feature of the USB-C protocol allowing devices to negotiate and deliver power at different voltages and currents according to various embodiments of this invention. This negotiation may occur dynamically between the power source (such as a charger or power bank) and the receiving device (such as a smartphone or laptop) based on their capabilities and power requirements. USB PD supports multiple power profiles, ranging from 5 volts (V) to 48 volts (V) and currents up to 5 amperes (A) for fast charging of devices. The negotiation process may involve the exchange of messages between the devices to determine the optimal power delivery parameters. Once voltage, current, and power direction are determined, the power transfer may begin. USB-C power delivery also supports bi-directional power flow allowing devices to act as both power sources and power sinks. This means that devices may charge each other or transfer power bi-directionally as needed.

A wired data transfer protocol such as the USB-C data transfer protocol may be used for data transfer. USB-C supports various data transfer modes and speeds, making it a versatile interface for connecting peripherals and data storage devices. USB-C data transfer protocol utilizes the Universal Serial Bus (USB) standard which specifies the communication protocol, electrical characteristics, and connectors for connecting devices and peripherals. USB-C offers several advantages over previous USB standards, including higher data transfer speeds, reversible connectors, and support for multiple protocols like USB 3.1, Thunderbolt 3, DisplayPort, and more. USB-C supports data transfer speeds ranging from USB 2.0 (up to 480 Mbps) to USB 3.1 Gen 2 (up to 10 Gbps) and beyond. This enables fast and efficient transfer of files, multimedia content, and other data between devices. USB-C data transfer protocol also supports various data transfer modes including bulk transfer, isochronous transfer, and interrupt transfer allowing devices to communicate with each other based on their specific requirements.

Near Field Communication (NFC) may also be included in the logic transmitter and receiver section according to various embodiments of this invention to allow short-range wireless communication technology that enables devices to exchange data when they are brought into close proximity, typically within a few centimeters of each other. NFC operates at radio frequencies (13.56 MHz) and is designed for simple and secure communication between devices, such as smartphones, tablets, and NFC-enabled tags or cards. NFC also enables contactless payment to provide secure transactions between a mobile device and a payment terminal. NFC also enables data exchange to share information such as contact details, photos, videos, URLs, and more. NFC also enables access control allowing users to authenticate themselves by tapping an NFC-enabled device or card on a reader. NFC also enables smart posters and tags embedded in posters, advertisements to open websites, launch apps, or to provide additional information. The NFC data transfer protocol operates in three modes including: Peer-to-Peer (P2P) Mode so that two NFC-enabled devices may exchange data directly with each other, enabling features like file sharing, gaming, and instant messaging. Read/Write Mode: Enables an NFC-enabled device to read data from or write data to an NFC tag or card, facilitating applications like access control, ticketing, and information retrieval. Card Emulation Mode to allow an NFC-enabled device to emulate an NFC tag or card, enabling mobile payments and access control without the need for a physical card.

The charge unit 900 (as shown in FIG. 9) according to various embodiments of this invention may include a network system for use with this invention to negotiate the point of service transaction and to gather and manage/monetize data. The charge portal/point of service device may be located in a high traffic area. The charge portal may be connected to a base server (cloud) to manage the transaction and gather data. The base server may also connect to the cellular device to gather data on the consumer. The base server may connect to a server owned by the point-of-sale location, for example a coffee shop or other retail establishment. The point-of-sale server may then connect with the consumer device, either directly or through the base server, to provide advertising or other consumer engagement information. A third-party media server may be used to provide entertainment or advertising directly to the consumer device or via the base server. A data mining server may also be used to gather and communicate data to the point of service server and to communicate with third party data users. The third-party data users may use customer data in marketing to the consumer or may agglomerate the data for other uses. The data may be used for any number of programs, provided consumer data protections are maintained. Consumer loyalty, support, engagement, acquisition, affinity, rewards, membership, and communication may be managed through the various servers. Tickets, services, gamification, tokens, passes, vouchers, entertainment and support are other uses for the data. Community, networking, product support, safety and tracking data may also be gathered.

Various embodiments of this invention have been described above both generically and with regard to specific embodiments. Although the invention has been set forth herein, a wide variety of alternatives known to those of skill in the art can be selected within the generic disclosure. The invention is not otherwise limited, except for the recitation of the claims set forth below.

We claim:

1. A hybrid charge and data transfer system, comprising:
a receiver module having arrays of positioning/detection connections and groups of voltage bus and groups of ground connections; and
a transmitter module having a rotational structure defined by arrays of positioning/detection pins, the positioning pins match with positioning connections on the receiver module to determine presence of the receiver module and switch input power between a wireless to the physical connection between groups of voltage bus pins and groups of ground pins.

2. The hybrid charge and data transfer system of claim 1 wherein the system supports universal serial bus standards via multi-group high-speed transfer switches to retain the data function of existing USB.

3. The hybrid charge and data transfer system of claim 2 wherein the connection is maintained in four positions of North, East, South, West (0, 90, 180 and 270 degrees).

4. The hybrid charge and data transfer system, of claim 2 wherein the connection is maintained in two positions of North, East (0, 90 degrees).

5. The hybrid charge and data transfer system of claim 1 wherein the system supports power output up to 140 W (28v 5 A).

6. The hybrid charge and data transfer system of claim 1 wherein the surface mount further comprises:
a plurality of electronic pin connectors having a series of conductive pins arranged in a grid pattern.

7. The hybrid charge and data transfer system of claim 1 wherein the surface mount further comprises:
a plurality of surface connections which are applied by a process selected from the group consisting of: electroplated, sputtered, chemical vapor deposited, physical vapor deposition, thermal sprayed, screen printed and any other suitable process.

8. The hybrid charge and data transfer system of claim 1 wherein the wireless power transfer is managed in accordance with the Qi protocol.

9. The hybrid charge and data transfer system of claim 1 wherein the direct power and data transfer is managed in accordance with the USB-C PD protocol.

10. The hybrid charge and data transfer system of claim 1 further comprising:
a near field communication system for contactless data exchange.

11. A network system for the point of service transactions and data gathering comprising:
a hybrid charge portal/point of service for both wireless and direct power and data transfer to a consumer device; and
a base server linked to the charge portal connected to manage the transaction and gather data.

12. The network system for the point of service transactions and data gathering of claim 9 wherein the base server connects to the cellular device to gather data on a consumer.

13. The network system for the point of service transactions and data gathering of claim 9 wherein the base server connects to a server owned by the point-of-sale location to provide advertising or other consumer engagement information.

14. The network system for the point of service transactions and data gathering of claim 9 wherein the base server connects to a third-party media server to provide entertainment or advertising directly to the consumer.

15. The network system for the point of service transactions and data gathering of claim 9 wherein the base server connects to a data mining server to gather and communicate data to the point of service server and to communicate with third party data users.

16. The network system for the point of service transactions and data gathering of claim 9 wherein the customer data is used for one of consumer loyalty, support, engagement, acquisition, affinity, rewards, warranty, membership, tickets, services, gamification, tokens, passes, vouchers entertainment community, networking, product support, safety, and tracking.
